(19) United States
(12) Patent Application Publication
(10) Pub. No.: US 2020/0388935 A1
(43) Pub. Date: Dec. 10, 2020

(54) APPARATUS AND METHOD FOR TRANSMITTING AND RECEIVING DATA USING ANTENNA ARRAY IN WIRELESS COMMUNICATION SYSTEM

(71) Applicant: POSTECH Research and Business Development Foundation, Pohang-si (KR)

(72) Inventors: Namyoon LEE, Pohang-si (KR); Heedong DO, Pohang-si (KR)

(21) Appl. No.: 16/894,172

(22) Filed: Jun. 5, 2020

(30) Foreign Application Priority Data
Jun. 5, 2019 (KR) 10-2019-0066687

(51) Int. Cl. H01Q 21/24; H01Q 1/24; H04B 7/06; H01Q 21/06; H04L 27/26; H04B 7/0456

(52) U.S. Cl. CPC H01Q 21/24; H01Q 1/246; H04B 7/0456; H01Q 21/061; H04L 27/2628; H04B 7/0617

(57) ABSTRACT

A method for transmitting and receiving data through an antenna array in a wireless communication system is provided. The method of operating a first device includes identifying a plurality of subarrays formed from a planar lattice array, and transmitting symbols to a second device through the plurality of subarrays, wherein the subarrays form a plurality of Uniform Circulant Arrays (UCAs) from the planar lattice antenna array, and wherein antenna elements allocated to each of the subarrays are located at equal intervals to have an equal distance from the center of the planar lattice array.

### CROSS-REFERENCE TO RELATED APPLICATION(S)

This application is based on and claims priority under 35 U.S.C. § 119(a) to Korean patent application number 10-2019-0066687, filed on Jun. 5, 2019, in the Korean Intellectual Property Office, the disclosure of which is incorporated by reference herein in its entirety.

### BACKGROUND

### 1. Field

The disclosure relates to a wireless communication system. More particularly, the disclosure relates to an apparatus and a method for transmitting and receiving data using an antenna array in a wireless communication system.

### 2. Description of Related Art

With the development of communication technologies, various services using communication technologies have been made. Some services require data communication having very high throughput. Accordingly, research on technologies for large data transmission in various environments is actively progressed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method for effectively transmitting and receiving data through antenna arrays in a wireless communication system.

Another aspect of the disclosure is to provide an apparatus and a method for performing Orbital Angular Momentum (OAM) multiplexing transmission through a planar lattice antenna array in a wireless communication system.

Another aspect of the disclosure is to provide an apparatus and a method for forming an effective channel in the form of Block Circulant with Circulant Blocks (BCCB) using iterative transmission of symbols in a wireless communication system.

Another aspect of the disclosure is to provide an apparatus and a method for performing OAM multiplexing transmission using Uniform Linear Arrays (ULAs) or Uniform Rectangular Arrays (URAs) in a wireless communication system.

Additional aspects will be set forth in part in the description which follows and, in part, will be apparent from the description, or may be learned by practice of the presented embodiments.

In accordance with an aspect of the disclosure, a method of operating a first device in a wireless communication system is provided. The method includes identifying a plurality of subarrays formed from a planar lattice array, and transmitting symbols to a second device through the plurality of subarrays, wherein the subarrays form a plurality of Uniform Circulant Arrays (UCAs) from the planar lattice antenna array, and antenna elements allocated to each of the subarrays are located at equal intervals to have an equal distance from the center of the planar lattice array.

In accordance with another aspect of the disclosure, a method of operating a second device in a wireless communication system is provided. The method includes identifying a plurality of subarrays formed from a planar lattice array, and receiving symbols from a first device through the plurality of subarrays, wherein the subarrays form a plurality of Uniform Circulant Arrays (UCAs) from the planar lattice antenna array, and antenna elements allocated to each of the subarrays are located at equal intervals to have an equal distance from the center of the planar lattice array.

In accordance with another aspect of the disclosure, a first device in a wireless communication system is provided. The first device includes a transceiver, and at least one processor connected to the transceiver, wherein the at least one processor identifies a plurality of subarrays formed from a planar lattice array and transmits symbols to a second device through the plurality of subarrays, the subarrays form a plurality of Uniform Circulant Arrays (UCAs) from the planar lattice antenna array, and antenna elements allocated to each of the subarrays are located at equal intervals to have an equal distance from the center of the planar lattice array.

In accordance with another aspect of the disclosure, a second device in a wireless communication system is provided. The second device includes a transceiver, and at least one processor connected to the transceiver, wherein the at least one processor identifies a plurality of subarrays formed from a planar lattice array and receives symbols from a first device through the plurality of subarrays, the subarrays form a plurality of Uniform Circulant Arrays (UCAs) from the planar lattice antenna array, and antenna elements allocated to each of the subarrays are located at equal intervals to have an equal distance from the center of the planar lattice array.

An apparatus and a method according to various embodiments can achieve high throughput by performing Orbital Angular Momentum (OAM) multiplexing transmission through antenna arrays in various forms.

Other aspects, advantages, and salient features of the disclosure will become more apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to an embodiment of the disclosure;

FIG. 2 is a block diagram of a device for performing communication in a wireless communication system according to an embodiment of the disclosure;

FIG. 3 illustrates a concept of Orbital Angular Momentum (OAM) multiplexing transmission in a wireless communication system according to an embodiment of the disclosure;

FIG. 4A illustrates Uniform Circular Arrays (UCAs) configured using an antenna array in a planar lattice structure in a wireless communication system according to an embodiment of the disclosure;

FIG. 4B illustrates an operation of subarray allocation for configuring UCAs in antenna arrays having a planar lattice structure in a wireless communication system according to an embodiment of the disclosure;

FIG. 4C illustrates an operation of subarray allocation for configuring UCAs in antenna arrays having a planar lattice structure in a wireless communication system according to an embodiment of the disclosure;

FIG. 5A illustrates an operation of a channel matrix in a case in which a plurality of UCAs are used in a wireless communication system according to an embodiment of the disclosure;

FIG. 5B illustrates an operation of a channel matrix multiplied by a DFT matrix and an IDFT matrix in a wireless communication system according to an embodiment of the disclosure;

FIG. 5C illustrates an operation of a permutated channel matrix in a wireless communication system according to an embodiment of the disclosure;

FIG. 6A is a flowchart illustrating a process of transmitting a signal in a wireless communication system according to an embodiment of the disclosure;

FIG. 6B is a flowchart illustrating a process for determining a precoding matrix in a wireless communication system according to an embodiment of the disclosure;

FIG. 6C is a flowchart illustrating a process for performing precoding in a wireless communication system according to an embodiment of the disclosure;

FIG. 7A is a flowchart illustrating a process for receiving a signal in a wireless communication system according to an embodiment of the disclosure;

FIG. 7B is a flowchart illustrating a process for performing postcoding in a wireless communication system according to an embodiment of the disclosure;

FIG. 8A illustrates signal symbols during a plurality of transmission opportunities in a wireless communication system according to an embodiment of the disclosure;

FIG. 8B illustrates an effective channel for a sum of signals transmitted during a plurality of transmission opportunities in a wireless communication system according to an embodiment of the disclosure;

FIG. 9 is a flowchart illustrating a process for configuring an effective channel in a form of Block Circulant with Circulant Blocks (BCCB) in a wireless communication system according to an embodiment of the disclosure;

FIG. 10 is a flowchart illustrating a process for detecting symbols based on an effective channel in the form of BCCB in a wireless communication system according to an embodiment of the disclosure;

FIG. 11 illustrates an operation of communication using Uniform Linear Arrays (ULAs) in a wireless communication system according to an embodiment of the disclosure;

FIG. 12 illustrates an operation of communication using Uniform Rectangular Arrays (URAs) in a wireless communication system according to an embodiment of the disclosure;

FIG. 13A illustrates an operation of communication using ULAs in a wireless communication system according to an embodiment of the disclosure;

FIG. 13B illustrates an operation of communication using ULAs in a wireless communication system according to an embodiment of the disclosure;

FIG. 14 illustrates an operation of UCAs in a wireless communication system according to an embodiment of the disclosure; and

FIG. 15 illustrates a performance of a transmission scheme according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms used in the disclosure are only used to describe specific embodiments, and are not intended to limit the disclosure. A singular expression may include a plural expression unless they are definitely different in a context. Unless defined otherwise, all terms used herein, including technical and scientific terms, have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Hereinafter, various embodiments of the disclosure will be described based on an approach of hardware. However, various embodiments of the disclosure include a technology that uses both hardware and software, and thus the various embodiments of the disclosure may not exclude the perspective of software.

The disclosure relates to an apparatus and a method for transmitting and receiving data through antenna arrays in a wireless communication system. Specifically, the disclosure describes a technology for transmitting and receiving data through Orbital Angular Momentum (OAM) multiplexing transmission in a wireless communication system.

Terms referring to a signal used in the following description, terms referring to a channel, terms referring to control information, terms referring to network entities, and terms referring to elements of a device are used only for convenience of description. Accordingly, the disclosure is not limited to those terms, and other terms having the same technical meanings may be used.

Further, the expression “larger than” or “smaller than” is used to determine whether a specific condition is satisfied or fulfilled, but is only to indicate an example and does not exclude “larger than or equal to” or “equal to or smaller than” A condition indicating “larger than or equal to” may be replaced with “larger than”, a condition indicating “equal to or smaller than” may be replaced with “smaller than”, and a condition indicating “larger than or equal to and smaller than” may be replaced with “larger than and smaller than”.

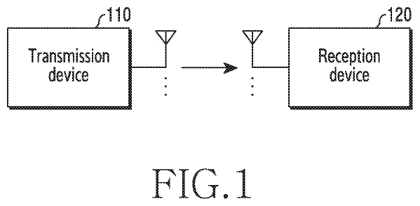

FIG. 1 illustrates a wireless communication system according to an embodiment of the disclosure. FIG. 1 illustrates a transmission device 110 and a reception device 120 as the part of devices or nodes using a radio channel in a wireless communication system. Although FIG. 1 illustrates one transmission device 110 and one reception device 120, a plurality of transmission devices or a plurality of reception devices may be included. The relation between transmission and reception is variable, and thus roles of the transmission device 110 and the reception device 120 may be exchanged.

Referring to FIG. 1, according to various embodiments of the disclosure, the transmission device 110 may transmit data through an antenna array, and the reception device 120 may receive data through an antenna array. For example, the transmission device 110 and the reception device 120 may perform Multiple Input Multiple Output (MIMO) communication using a plurality of streams or layers. Hereinafter, the transmission device 110 and the reception device 120 may be referred to as a “first device” and a “second device” or as a “communication device” or a “device”.

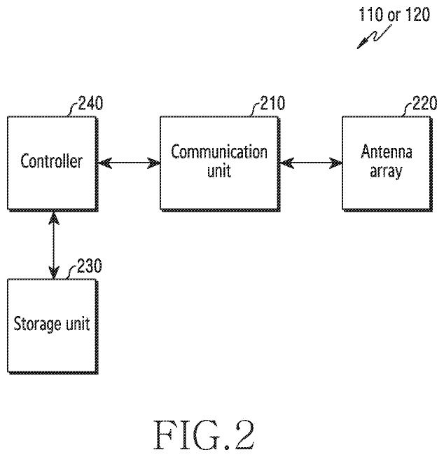

FIG. 2 is a block diagram of a device for performing communication in a wireless communication system according to an embodiment of the disclosure. For example, the configuration illustrated in FIG. 2 may be understood as the configuration of the transmission device 110 or the reception device 120. The term “ . . . unit”, or the ending of a word, such as “ . . . or”, “ . . . er”, or the like, may indicate a unit of processing at least one function or operation, which may be embodied in hardware, software, or a combination of hardware and software.

Referring to FIG. 2, the device may include a communication unit 210, an antenna array 220, a storage unit 230, and a controller 240.

The communication unit 210 may perform functions for transmitting and receiving a signal through a radio channel. For example, the communication unit 210 may perform a function for conversion between a baseband signal and a bitstream according to a physical layer standard of a system. For example, in data transmission, the communication unit 210 may generate complex symbols by coding and modulating a transmission bitstream. In data reception, the communication unit 210 may reconstruct a reception bitstream through demodulation and decoding of the baseband signal. Further, the communication unit 210 may up-convert a baseband signal into a Radio Frequency (RF) band signal and transmit the same through an antenna, and may down-convert an RF band signal received through an antenna into a baseband signal.

To this end, the communication unit 210 may include a transmission filter, a reception filter, an amplifier, a mixer, an oscillator, a Digital-to-Analog Convertor (DAC), an Analog-to-Digital Convertor (ADC), and the like. Further, the communication unit 210 may include a plurality of transmission/reception paths. In addition, the communication unit 210 may include at least one antenna array including a plurality of antenna elements. On the hardware side, the communication unit 310 may include a digital unit and an analog unit, and the analog unit may include a plurality of subunits according to operation power, operation frequency, and the like. The communication unit 210 may include a decoder for performing decoding according to various embodiments of the disclosure.

The communication unit 210 transmits and receives the signal as described above. Accordingly, the communication unit 210 may be referred to as a “transmitter”, a “receiver”, or a “transceiver”. In addition, the transmission and reception performed through a radio channel may be understood to mean that the above-described processing is performed by the communication unit 210 in the following description.

The antenna array 220 includes a plurality of antenna elements. Each of the plurality of antenna elements is an element for radiating a signal from the communication signal 210 or detecting a signal transmitted through a radio channel. The plurality of antenna elements may be arranged in a planer lattice structure or in a circular structure. In the case of arrangement in the circular structure, antenna elements may be arranged on a plurality of concentric circles. The plurality of antenna elements included in the antenna array 220 may be divided into a plurality of subarrays. Accordingly, a set of subarrays may be formed.

The storage unit 230 may store data, such as a basic program, an application, or configuration information for the operation of the reception device 120. The storage unit 230 may be configured as volatile memory, nonvolatile memory, or a combination of volatile memory and nonvolatile memory. The storage unit 230 may provide stored data in response to a request from the controller 240.

The controller 240 may control the overall operation of the device. For example, the controller 240 may transmit and receive signals through the communication unit 210. Further, the controller 240 may record data in the storage unit 230 or read the data. To this end, the controller 240 may include at least one processor or microprocessor, or may play the part of the processor. According to various embodiments of the disclosure, the controller 240 may control the device to perform operations according to various embodiments described below.

In communication between two devices (for example, the transmission device 110 and the reception device 120), a Line of Sight (LOS) environment in which locations of the transmission device and the reception device are fixed may be assumed. Due to the appearance of a tera-hertz kiosk system and a millimeter wave cellular system, interest in the LOS environment of the fixed location increases. It is expected that future applications using communication will require very high throughput using a limited bandwidth, and accordingly an increase in spectral efficiency is a subject of intense interest.

In one method of increasing spectral efficiency, spatial multiplexing using multiple antenna elements plays a pivotal role. However, the use of the spatial multiplexing is not feasible under a LOS Multiple Input Multiple Output (MIMO) channel condition. This is because a channel scattering effect is not pronounced in the LOS environment. Accordingly, in the LOS environment, it is not easy to fully exploit a spatial degree of freedom in a MIMO channel.

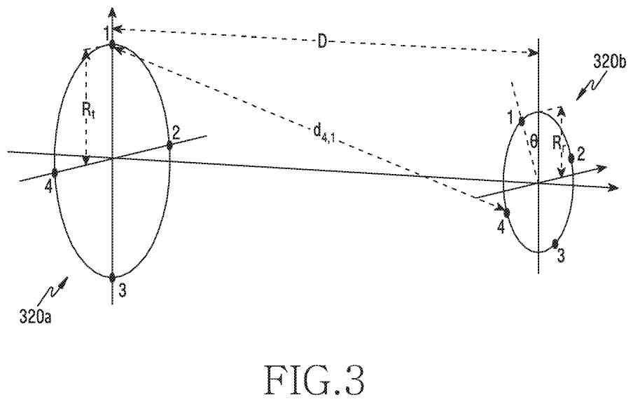

A multiplexing gain in a LOS MIMO channel may be obtained using an OAM multiplexing transmission scheme. A key idea of OAM multiplexing is transmission of multiple data symbols through a set of orthogonal electromagnetic (EM) waves. OAM multiplexing transmission may linearly scale a capacity of the LOS MIMO channel according to the number of orthogonal OAM modes. One method of realizing OAM multiplexing may consider the use of Uniform Circular Arrays (UCAs) by a transmission device and a reception device. The use of UCAs enables multiplexing and demultiplexing by precoding and decoding based on simple Discrete Fourier Transform (DFT). The concept of OAM transmission using the UCA is described below with reference to FIG. 3.

FIG. 3 illustrates a concept of OAM multiplexing transmission in a wireless communication system according to an embodiment of the disclosure.

Referring to FIG. 3, OAM multiplexing may be performed using antenna arrays 320a and 320b arranged in a circle. The transmission antenna array 320a or the reception antenna array 320b may be understood as a subarray including an antenna array (for example, the antenna array 220) included in the device or some antenna elements of the antenna array.

Referring to FIG. 3, in the state in which the transmission antenna array 320a and the reception antenna array 320b are spaced apart from each other by D and face each other while centers thereof are aligned, signals transmitted from four antenna elements of the transmission antenna array 320a are received by four antenna elements of the reception antenna array 320b. In this case, the distance between each antenna element of the transmission antenna array 320a and each antenna element of the reception antenna array 320b may be expressed as Equation 1 below.

$$\begin{matrix}{d}_{m , n} = \sqrt{{D}^{2} + {R}_{r}^{2} - 2 {R}_{r} cos ( θ - 2 π ( n - m ) / N )} \\ \approx D + \frac{1}{2 D} ( {D}^{2} + {R}_{r}^{2} - 2 {R}_{r} cos ( θ - 2 π ( n - m ) / N )\end{matrix} \qquad Equation 1$$

In Equation 1, d_{m,n} denotes a distance between an n antenna element of the transmission antenna array and an m^{th} antenna element of the reception antenna array, D denotes a distance between the center of the transmission antenna array and the center of the reception antenna array, Rᵣ denotes a radius of the reception antenna array, Rₜ denotes a radius of the reception antenna array, n denotes an antenna element index of the transmission antenna array, m denotes an antenna element index of the reception antenna array, and N denotes the number of antenna elements of the transmission antenna array.

Referring to FIG. 3 and Equation 1, d_{1,1}, d_{2,1}, d_{3,1}, d_{4,1} are the same as d_{2,2}, d_{3,2}, d_{4,2}, d_{1,2}. For example, channels between one antenna element of the transmission antenna array 320a and four antenna elements of the reception antenna array 320b and channels between another antenna element of the transmission antenna array 320a and four antenna elements of the reception antenna array 320b have the cyclic shift relation. Similarly, channels between four antenna elements of the transmission antenna array 320a and one antenna element of the reception antenna array 320b and channels between four antenna element of the transmission antenna array 320a and another antenna element of the reception antenna array 320b have the cyclic shift relation. Accordingly, a channel matrix which can be expressed as 4×4 channel values has the form of a circulant block as shown in Equation 2.

$$\begin{matrix}H = exp ( - j \frac{2 π}{λ} {d}_{n , m} ) ) \\ \approx exp ( - j \frac{2 π}{λ} ( D + \frac{{R}_{r}^{2} + {R}_{t}^{2}}{2 D} ) ) \\ ( exp ( j \frac{2 π {R}_{r} {R}_{f}}{λ D} cos ( θ - 2 π ( n - m ) / N ) )\end{matrix} \qquad Equation 2$$

In Equation 2, H denotes a channel matrix between the transmission antenna array and the reception antenna array, λ denotes a wavelength of a signal, d_{m,n} denotes a distance between an n^{th} antenna element of the transmission antenna array and an m^{th} antenna element of the reception antenna array, D denotes a distance between the center of the transmission antenna array and the center of the reception antenna array, Rᵣ denotes a radius of the reception antenna array, Rₜ denotes a radius of the reception antenna array, n denotes an antenna element index of the transmission antenna array, m denotes an antenna element index of the reception antenna array, and N denotes the number of antenna elements of the transmission antenna array.

For convenience of description, the channel matrix in Equation 2 may be expressed as Equation 3 below.

$$H = [ \begin{matrix}a & b & c & d \\ d & a & b & c \\ c & d & a & b \\ b & c & d & a\end{matrix} ] \qquad Equation 3$$

In Equation 2, H denotes a channel matrix, and each of a, b, c, and d denotes a channel coefficient which can be expressed as a complex number. As shown in Equation 2, rows of the channel matrix have the cyclic shift relation.

When a plurality of subarrays are used and each subarray satisfies the relation as shown in FIG. 3, the channel matrix may have the form including a plurality of circulant blocks.

Limitation of OAM multiplexing transmission is that the number of orthogonal OAM modes (for example, subchannels) for multiplexing is actually limited. An EM wave corresponding to an OAM signal may be severely divergent as an order of an OAM mode increases. The divergent effect may cause degradation of a signal quality (for example, a Signal to Noise Ratio (SNR)). Accordingly, the degree of freedom for a LOS MIMO channel has difficulty in linearly increasing according to the number of antennas.

Therefore, the disclosure proposes a transmission scheme using a combination of spatial multiplexing and OAM multiplexing. The proposed scheme may be referred to as “doubly-multiplex MIMO transmission”, but the disclosure is not limited to the corresponding term. According to various embodiments of the disclosure, when the transmission device and the reception device use K UCAs and each UCA includes M antenna elements, spectral efficiency is linearly scaled KM times. Such an achievement result may be proved by the MIMO of the related art precoding and decoding scheme based on Singular Value Decomposition (SVD). Calculation complexity of the scheme based on SVD is O (M³K³), but complexity of the proposed scheme may be significantly reduced through the use of DFT operation.

According to various embodiments of the disclosure, UCAs for OAM multiplexing transmission may be formed from an antenna array in a planar lattice structure.

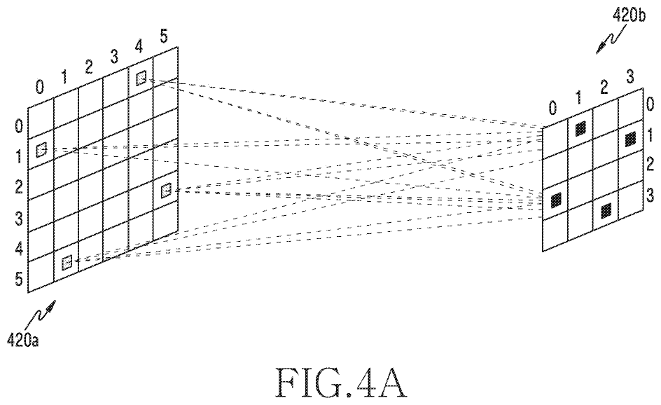

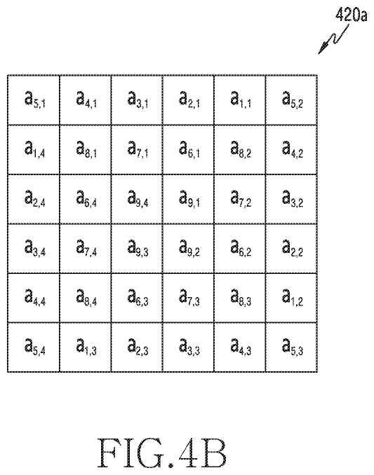

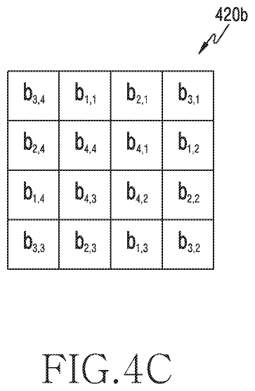

FIG. 4A illustrates UCAs configured using an antenna array in a planar lattice structure in a wireless communication system according to an embodiment of the disclosure.

Referring to FIG. 4A, a transmission antenna array 420a and a reception antenna array 420b have a planar lattice structure. In the example of FIG. 4A, the transmission antenna array 420a has a lattice structure having the size of 6×6, and the reception antenna array 420b has a lattice structure having the size of 4×4. When at least some of the antenna elements located in the same distance from the center of the antenna array 420a or 420b in the lattice structure are selected at equal intervals, the selected antenna elements may be used as one UCA. At this time, the number of antenna elements selected for one UCA may be the same as the number of modes.

In the example of FIG. 4A, antenna elements located at (0,4), (4,5), (5,1), and (1,0) in the transmission antenna array 420a are allocated to configure the transmission UCA, and antenna elements located at (0,1), (1,3), (3,2), and (0,2) in the reception antenna array 420b are allocated to configure the reception UCA. In a similar way, at least one other UCA may be configured in the transmission antenna array 420a or the reception antenna array 420b. When UCAs including four modes are configured, a maximum of nine UCAs may be configured in the transmission antenna array 420a and a maximum of four UCAs may be configured in the reception antenna array 420b. When a maximum number of UCAs is formed, an example of allocation of antenna elements is as illustrated in FIGS. 4B and 4C.

FIG. 4B illustrates an operation of subarray allocation for configuring UCAs in antenna arrays having a planar lattice structure in a wireless communication system according to an embodiment of the disclosure, and FIG. 4C illustrates an operation of subarray allocation for configuring UCAs in antenna arrays having a planar lattice structure in a wireless communication system according to an embodiment of the disclosure.

Referring to FIGS. 4A and 4B, a_{k,m} denotes an m^{th} antenna element allocated to a subarray for a k^{th} UCA in FIG. 4A, and b_{l,m} denotes an m^{th} antenna element allocated to a subarray for an l^{th} UCA in FIG. 4B. Referring to FIG. 4A, 9 UCAs may be configured by allocating 4 antenna elements to one subarray. Referring to FIG. 4B, 4 UCAs may be configured by allocating 4 antenna elements to one subarray. Antenna elements included in each subarray are located at equal intervals in lines of a circle drawn with the center as the center of the corresponding antenna array, and all subarrays are located in lines of concentric circles having the same diameter or different diameters.

Referring to FIGS. 4A, 4B, and 4C, the device according to various embodiments may define a plurality of subarrays by separating antenna elements of the antenna array having the planar lattice structure and use the plurality of subarrays as UCAs. In this case, the entire channel matrix may be expressed as Equation 4 below.

$$H = [ \begin{matrix}{H}_{1 , 1} & {H}_{1 , 2} & … & {H}_{1 , K} \\ {H}_{2 , 1} & {H}_{2 , 2} & … & {H}_{2 , K} \\ ⋮ & ⋮ & ⋱ & ⋮ \\ {H}_{L , 1} & {H}_{L , 2} & … & {H}_{L , K}\end{matrix} ] \qquad Equation 4$$

In Equation 4, H denotes a channel matrix, H_{l,k} denotes a matrix having the form of a circulant block as a channel matrix between a k^{th} subarray of a transmission antenna array and an l^{th} subarray of a reception antenna array, L denotes the number of subarrays of the reception antenna array, and K denotes the number of subarrays of the transmission antenna array.

Channel coefficients included in circulant blocks may be expressed as Equation 5 below.

$${h}_{m , n} \approx \frac{λ}{4 π D} {e}^{- j \frac{2 π}{λ} D} , {e}^{- j \frac{2 π {R}_{r} {R}_{t}}{λ D} cos ( θ - 2 π ( n - m ) / N ) .} \qquad Equation 5$$

In Equation 5, h_{m,n} denotes a channel coefficient between an n^{th} antenna element of a subarray of a transmission device and an m^{th} antenna element of a subarray of a reception device, λ denotes a wavelength of a signal, D denotes a distance between a subarray of the transmission device and a subarray of the reception device, Rᵣ denotes a radius of a subarray of the reception device, Rₜ denotes a radius of a subarray of the transmission device, n denotes an antenna element index of a subarray of the transmission device, m denotes an antenna element index of a subarray of the reception device, and N denotes the number of antenna elements of a subarray of the transmission device.

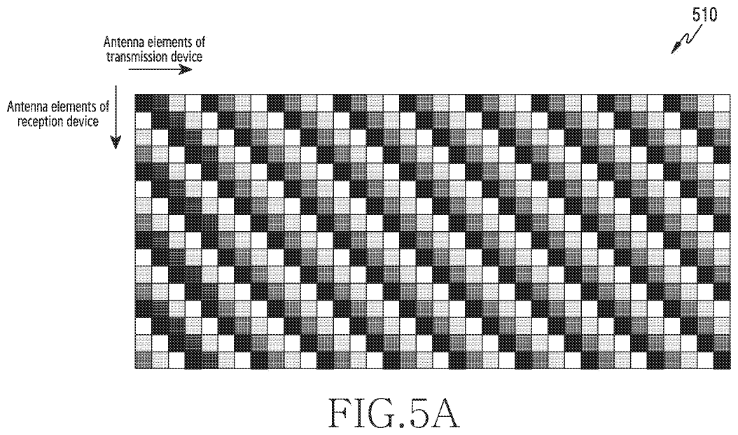

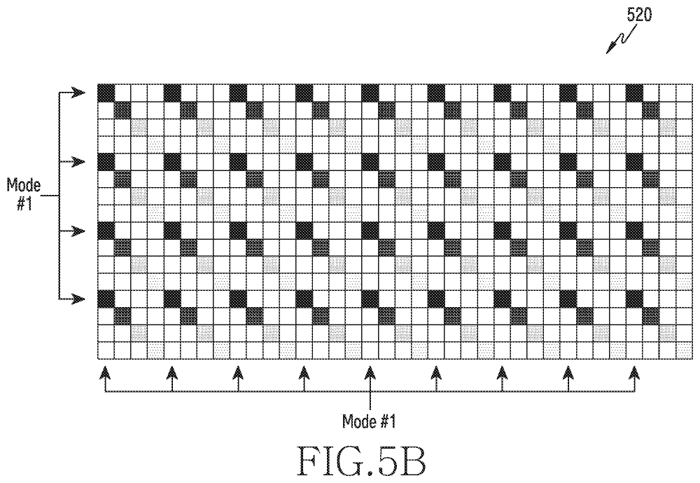

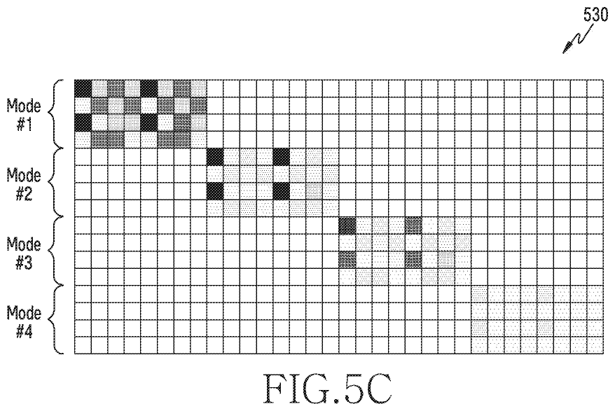

Hereinafter, the disclosure describes an effective channel which can be generated using the characteristic of the channel matrix as described above with reference to FIGS. 5A to 5C. In FIGS. 5A to 5C, rows correspond to antenna elements of a reception device and columns correspond antenna elements of a transmission device.

FIG. 5A illustrates an operation of a channel matrix in a case in which a plurality of UCAs are used in a wireless communication system according to an embodiment of the disclosure. FIG. 5A illustrates a channel matrix 510 in the case in which an antenna array of the transmission device includes 36 antenna elements, an antenna array of the reception device includes 16 antenna elements, and a subarray for one UCA includes 4 antenna elements.

Referring to FIG. 5A, the channel matrix includes circulant blocks having the size of 4×4. The size of one circulant block depends on the number of antenna elements allocated for one UCA. Since 9 UCAs are configured in the transmission device and 4 UCAs are configured in the reception device, a total of 36 circulant blocks are included in the channel matrix 510.

A matrix 520 as illustrated in FIG. 5B may be obtained by multiplying a Discrete Fourier Transform (DFT) matrix and an inverse DFT (IDFT) matrix by the channel matrix of FIG. 5A. For example, the multiplication of the DFT matrix and the IDFT matrix may be performed as Equation 6 below.

(I^{L}⊗F_{M})H(I_{K}└F_{M}⁻¹) Equation 6

In Equation 6, I_{L} denotes an identity matrix having the size of L, F_{M} denotes a DFT matrix having the size of M, H denotes a channel matrix, I_{K} denotes an identity matrix having the size of K, and F_{M1} denotes an IDFT matrix having the size of M.

FIG. 5B illustrates an operation of a channel matrix multiplied by a DFT matrix and an IDFT matrix in a wireless communication system according to an embodiment of the disclosure. FIG. 5B illustrates the result of multiplication of the DFT matrix and the IDFT matrix by the channel matrix of FIG. 5A.

Referring to FIG. 5B, circulant blocks may be diagonalized by multiplying the DFT matrix and the IDFT matrix.

Diagonal elements included in each circulant block correspond to different modes. For precoding or postcoding, diagonal elements may be grouped for each mode. For example, as illustrated in FIG. 5B, when 4 diagonal elements exist, 4 diagonal elements may be grouped to be included in one of 4 groups. For example, grouping may be performed by permutation as shown in Equation 7 below.

S_{M,L}^{T}(I_{L}⊗F_{M})H(I_{K}εF_{M}⁻¹)S_{M,K} Equation 7

In Equation 7, S_{M,L} denotes a permutation matrix having the size of M×L, I_{L} denotes an identity matrix having the size of L, F_{M} denotes a DFT matrix having the size of M, H denotes a channel matrix, I_{K} denotes an identity matrix having the size of K, F_{M}⁻¹ denotes an IDFT matrix having the size of M, and S_{M,K} denotes a permutation matrix having the size of M×K

For example, a permutation matrix 530 is as shown in FIG. 5C.

FIG. 5C illustrates an operation of a permutated channel matrix in a wireless communication system according to an embodiment of the disclosure. FIG. 5C illustrates a result of permutation of a matrix illustrated in FIG. 5B. Permutation may be performed such that elements included in the same group are adjacent to each other in a row axis and a column axis. Accordingly, a block diagonal matrix illustrated in FIG. 5C may be obtained. Each block included in the block diagonal matrix corresponds to one group.

Referring to FIG. 5C, an operation for detecting a signal based on the structure may be more simplified than that in the art of the related art. For example, as illustrated in FIG. 5C, an operation for MIMO detection may be required for each block rather than the entire matrix due to the block diagonal matrix. Accordingly, the size of a matrix for which the MIMO detection operation is performed may be reduced. For example, an SVD operation may be used. Each block may be decomposed by the SVD operation as shown in Equation 8 below.

H_{l,k}=U_{l,k}Σ_{l,k}V_{l,k}^{H} Equation 8

In Equation 8, H_{l,k} denotes a channel matrix between a k^{th} subarray of a transmission antenna array and an l^{th} subarray of a reception antenna array, U_{l,k} denotes a left singular vector, Σ_{l,k} denotes a diagonal matrix, and V_{l,k} denotes a right singular vector.

The right singular vector (for example, V) obtained through the SVD operation may be used to precode transmission symbols corresponding to the corresponding block in the transmission device. In this case, Hermitian (for example, UH) of the left singular vector obtained through the SVD operation may be used to postcode reception symbols corresponding to the corresponding block in the reception device.

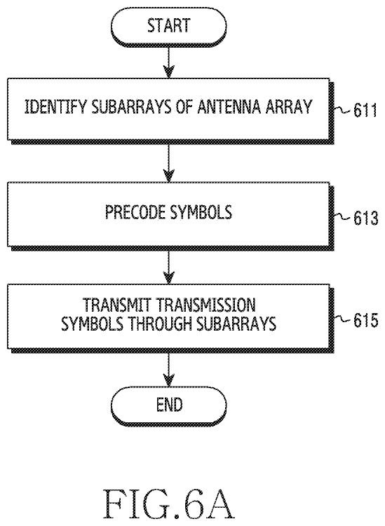

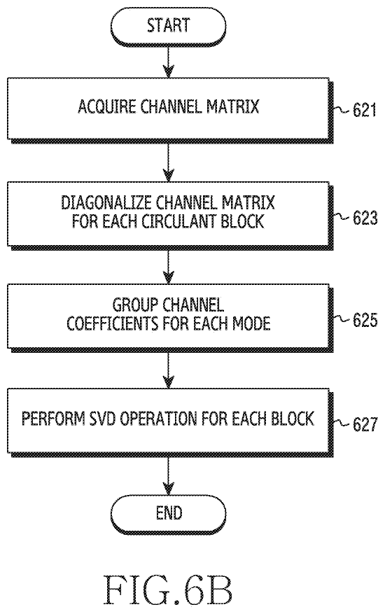

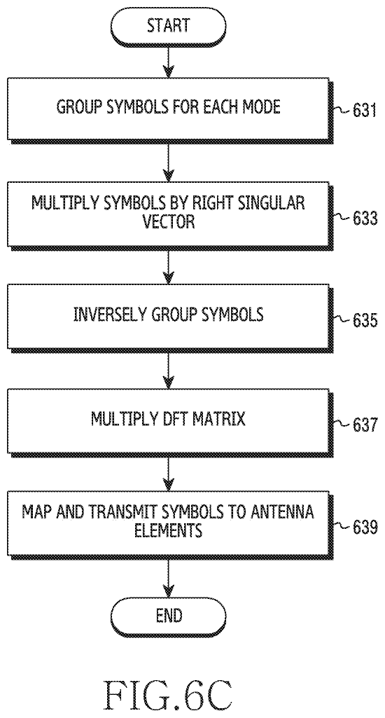

FIG. 6A is a flowchart illustrating a process of transmitting a signal in a wireless communication system according to an embodiment of the disclosure. FIG. 6A illustrates a method of operating a device (for example, the transmission device 110).

Referring to FIG. 6A, in operation 611, the device identifies subarrays of an antenna array. Each of the subarrays includes some of antenna elements of the antenna array (for example, a planar lattice antenna array), and antenna elements included in one subarray form one UCA. For example, antenna elements included in one subarray are located at the same distance from the center of the antenna array and are disposed at equal intervals from each other. Subarrays may be predefined or adaptively determined according to a given condition. For example, the given condition may be associated with at least one of a capability of a counterpart device (for example, the reception device 120), an amount of data to be transmitted, a service type, and a channel quality.

In operation 613, the device precodes symbols. The precoding may be performed based on a channel characteristic determined by UCAs configured by each of the subarrays. The precoding includes multiplication of at least one matrix or vector and symbols. For example, at least one matrix may include a matrix (for example, a DFT matrix) that does not depend on a channel. For precoding, symbols may be grouped based on UCA mode.

In operation 615, the device transmits symbols through subarrays. The device may map subarrays corresponding to precoded symbols to antenna elements and transmit the same. At this time, the device may inversely group the symbols grouped for each mode and map the symbols to antenna elements.

In the embodiment described with reference to FIG. 6A, the device performs precoding. According to an embodiment of the disclosure, the operation of performing precoding may be omitted. For example, when a detection scheme that does not need Channel State Information at Transmitter (CSIT) is used, the precoding operation may be excluded.

As described above with reference to FIG. 6A, the device may precode symbols in consideration with the channel characteristic generated by UCAs and transmit the symbols. At least one matrix for precoding may include a matrix that does not depend on a channel and further include a matrix that depends on a channel. For example, the matrix that does not depend on a channel may be determined by the SVD operation. An embodiment of determining the matrix for precoding through the SVD operation is described below with reference to FIG. 6B.

FIG. 6B is a flowchart illustrating a process for determining a precoding matrix in a wireless communication system according to an embodiment of the disclosure. FIG. 6B illustrates a method of operating a device (for example, the transmission device 110).

Referring to FIG. 6B, in operation 621, the device acquires a channel matrix. Information on the channel matrix may be acquired from a feedback from a counterpart device (for example, the reception device 120). In this case, the device may transmit a signal (for example, a reference signal) for channel estimation. Alternatively, when transmission and reception frequencies are the same, information on the channel matrix may be estimated by the device using the signal transmitted by the counterpart device. For example, the channel matrix may have the characteristic illustrated in FIG. 5A.

In operation 623, the device diagonalizes the channel matrix for each circulant block. For example, the device may diagonalize the channel matrix for each circulant block by multiplying an IDFT matrix and a DFT matrix by the channel matrix. For example, the device may transform the channel matrix to have the form illustrated in FIG. 5B by performing the operation of Equation 6.

In operation 625, the device groups channel coefficients for each mode. To this end, the device may multiply the channel matrix diagonalized for each block by a permutation matrix. For example, the device may transform the channel matrix to have the form of the permutation matrix illustrated in FIG. 5C by performing the operation of Equation 7.

In operation 627, the device performs the SVD operation for each block. Through the SVD operation, each block may be decomposed to a left singular vector, a diagonal matrix, and a right singular vector. For example, each block may be decomposed as shown in Equation 8. The right singular vector may be used as a matrix for precoding.

FIG. 6C is a flowchart illustrating a process for performing precoding in a wireless communication system according to an embodiment of the disclosure. FIG. 6C illustrates a method of operation a device (for example, the transmission device 110).

Referring to FIG. 6C, in operation 631, the device groups symbols for each mode. Precoding performed thereafter is performed for each mode. Accordingly, when symbols are mode-preferentially arranged, the device may rearrange the symbols for each mode to subarray-preferentially arrange the symbols. However, according to an embodiment of the disclosure, this operation may be omitted. For example, when a modulation operation for generating symbols includes rearrangement of the symbols, the order of symbols is appointed with a counterpart device (for example, the reception device 120), or symbols are rearranged when antenna elements are mapped, this operation may be omitted.

In operation 633, the device multiplies the symbols with the right singular vector. The right singular vector is multiplied for each grouped block. The device multiplies each of the right singular vectors corresponding to the number of blocks by symbols included in each block. The right singular vector may be obtained by the SVD operation for the blocks of which channel coefficients of the channel matrix are grouped for each mode.

In operation 635, the device inversely groups symbols. The device inversely groups the symbols through a scheme corresponding to the grouping performed in operation 631. Accordingly, the symbols may be mode-preferentially arranged again.

In operation 637, the device multiplies a DFT matrix. The device multiplies the DFT matrix by symbols such that an effective channel experienced by the counterpart device includes multiplication of an estimated channel and the DFT matrix. The DFT matrix may be multiplied for each subarray.

In operation 639, the device maps and transmits symbols to antenna elements. The device may identify a subarray and a mode of the subarray used for transmission of each of the symbols, and transmit each symbol through the corresponding antenna element according to the identified result.

In the embodiment described with reference to FIG. 6C, at least one of the grouping in operation 631 and the inverse grouping in operation 635 may be performed jointly with another operation. For example, by transforming the matrix or adding the operation in the multiplication operation of the vector or the matrix, a result which is the same as that of separate performance of grouping and inverse grouping may be obtained.

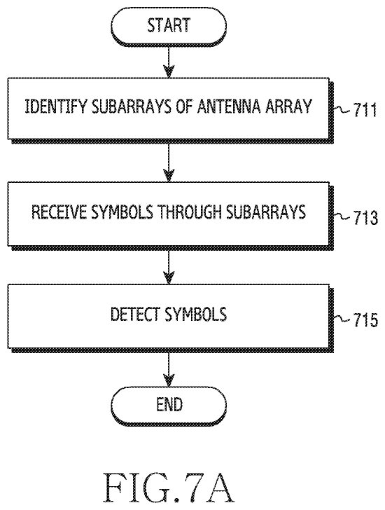

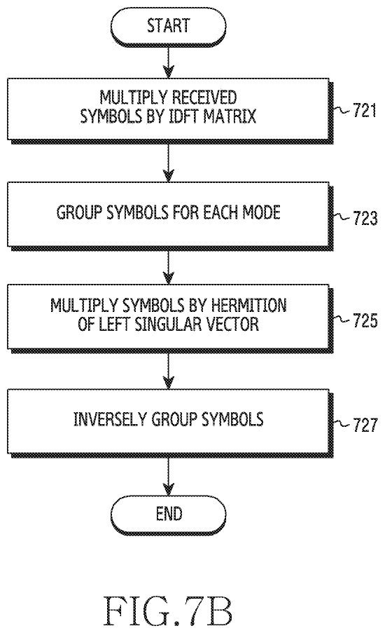

FIG. 7A is a flowchart illustrating a process for receiving data in a wireless communication system according to an embodiment of the disclosure. FIG. 7A illustrates a method of operating a device (for example, the reception device 120).

Referring to FIG. 7A, in operation 711, the device identifies subarrays of an antenna array. Each of the subarrays includes some of antenna elements of the antenna array (for example, a planar lattice antenna array), and antenna elements included in one subarray form one UCA. For example, antenna elements included in one subarray are located at the same distance from the center of the antenna array and are disposed at equal intervals from each other. Subarrays may be predefined or adaptively determined according to a given condition. For example, the given condition may be associated with at least one of a capability of a counterpart device (for example, the transmission device 110), an amount of data, a service type, and a channel quality.

In operation 713, the device receives symbols through subarrays. Symbols are received via a channel between an antenna array of the counterpart device and an antenna array of the device. An effective channel experienced by the symbols may vary depending on precoding performed by the counterpart device.

In operation 715, the device detects symbols. In order to detect the symbols, the device may perform postcoding. The postcoding may be performed based on a channel characteristic determined by UCAs configured by each of the subarrays. The precoding includes multiplication of at least one matrix or vector and symbols. For example, at least one matrix may include a matrix (for example, an IDFT matrix) that does not depend on a channel. For precoding, the received symbols may be grouped based on UCA mode.

In the embodiment described with reference to FIG. 7A, the device may perform postcoding on the received symbols. To this end, the device determines at least one matrix or vector for postcoding. At least one matrix for postcoding may be similar to operations for determining at least one matrix for precoding by the transmission device. For example, the device performs the procedure described with reference to FIG. 6B, but may use Hermitian of the left singular vector obtained through the SVD operation as at least one matrix for postcoding.

FIG. 7B is a flowchart illustrating a process for performing postcoding in a wireless communication system according to an embodiment of the disclosure. FIG. 7B illustrates a method of operating a device (for example, the reception device 120).

Referring to FIG. 7B, in operation 721, the device multiplies received symbols by an IDFT matrix. Accordingly, an effective channel matrix may be diagonalized in units of circulant blocks.

In operation 723, the device groups symbols for each mode. Thereafter, multiplication of Hermitian of the left singular vector is performed on symbols belonging to the same mode, and thus the device permutates the symbols. For example, the device rearranges symbols such that the symbols belonging to the same mode are adjacent to each other.

In operation 725, the device multiplies the symbols by Hermitian of the left singular vector. The left singular vector is multiplied for each grouped block. The device multiplies Hermitian of each of the left singular vectors corresponding to the number of blocks by symbols included in each block. The left singular vector may be obtained by the SVD operation for the blocks of which channel coefficients of the channel matrix are grouped for each mode. Accordingly, the grouped blocks of the effect channel matrix may be diagonalized. Therefore, the device may detect transmission symbols.

In operation 727, the device inversely groups symbols. Since the symbols are subarray-preferentially rearranged due to grouping for each mode, the device arranges the symbols according to the order before the rearrangement. However, according to an embodiment of the disclosure, this operation may be omitted. For example, when the demodulation operation of symbols performed later includes rearrangement of the symbols or when the order of symbols is appointed with a counterpart device (for example, the transmission device 110), this operation may be omitted.

In the embodiment described with reference to FIG. 7B, at least one of the grouping in operation 723 and the inverse grouping in operation 727 may be performed jointly with another operation. For example, by transforming the matrix or adding the operation in the multiplication operation of the vector or the matrix, a result which is the same as that of separate performance of grouping and inverse grouping may be obtained.

As described above, devices may configure a plurality of UCAs from the antenna array having the planar lattice structure and perform OAM multiplexing transmission through the UCAs. Accordingly, the size of a system to which the operation for MIMO detection is applied is reduced (for example, from KxLxM to K×L), and thus operation complexity may be reduced.

When circulant blocks included in the channel matrix have the circulant structure again, in other words, when the channel matrix has the form of a Block circulant with circulant blocks (BCCB), operation complexity may be further reduced. Hereinafter, embodiments for configuring the effective channel matrix to have the form of BCCB will be described.

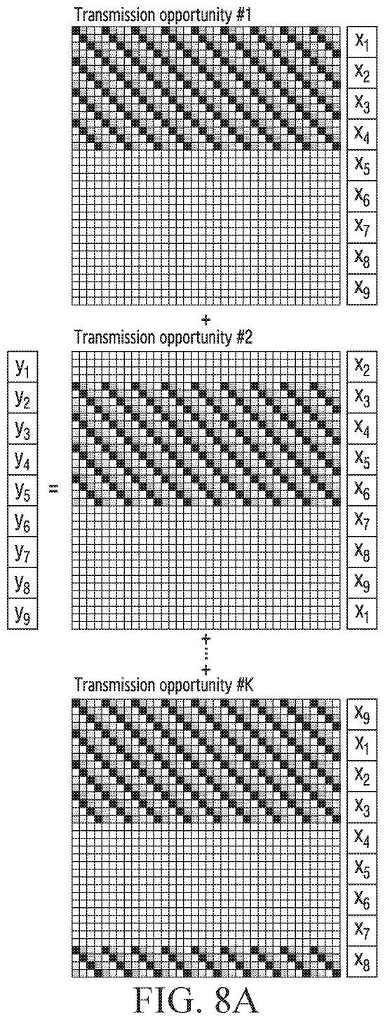

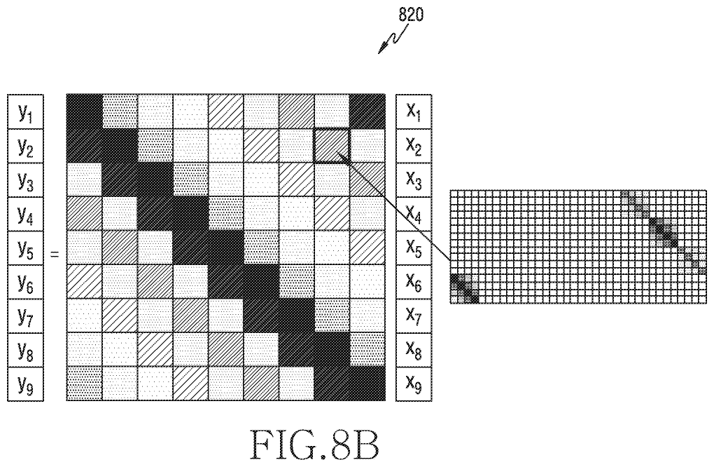

FIG. 8A illustrates signal symbols during a plurality of transmission opportunities in a wireless communication system according to an embodiment of the disclosure.

Referring to FIG. 8A, xₖ denotes a transmission symbols vector and yₖ denotes a summed reception symbol vector. The length of the transmission symbol vector and the reception symbol vector is the same as the number of UCA modes. Referring to FIG. 8A, transmission symbol vectors x₁ to x₉ are transmitted during K transmission opportunities. In each transmission opportunity, transmission symbol vectors x₁ to x₉ are cyclic-shifted in units of blocks. Specifically, transmission symbols vectors x₁, x₂, x₃, and x₄ may be transmitted in transmission opportunity #1, x₃, x₄, x₅, and x₆ may be transmitted in transmission opportunity #2, and x₉, x₁, x₂, and x₈ may be transmitted in transmission opportunity #K. K is the same as the number of UCAs configured in the transmission device, and the number of symbol vectors transmitted in one transmission opportunity is the same as the number of UCAs configured in the reception device.

The reception device may cyclic-shift symbol vectors received during K transmission opportunities in units of blocks. At this time, due to block cyclic shift by the transmission device and the reception device, an effective channel for each transmission opportunity is cyclic-shifted by one block in a row direction and by one block in a column direction. When the reception device sums block-cyclic-shifted symbol vectors received during K transmission opportunities, the effective channel is a sum of K matrixes that are block-shifted in the row direction and the column direction, which becomes a block circulant matrix. Further, each block of the effective channel is a sum of circulant matrixes, and thus the effective channel has the BCCB form. The effective channel matrix experienced by reception symbol vectors obtained through the sum may be expressed as FIG. 8B.

FIG. 8B illustrates an effective channel for a sum of signals transmitted during a plurality of transmission opportunities in a wireless communication system according to an embodiment of the disclosure.

Referring to FIG. 8B, an effective channel matrix 820 between summed reception symbol vectors y₁ to y₉ and transmission symbol vectors x₁ to x₉ has the BCCB form. In other words, each block of the effective channel matrix 820 is a circulant block, and the effective channel matrix 820 is a circulant block in units of blocks. In this case, when symbols are grouped for each mode, each of the grouped blocks also becomes a circulant block. The circulant block may be diagonalized by multiplication of an IDFT matrix and a DFT matrix.

According to an embodiment of the disclosure, MIMO detection for the grouped blocks may be performed by multiplication of the IDFT matrix and the DFT matrix. For example, in the embodiment described with reference to FIGS. 5A to 5C above, the SVD operation described as an example may be replaced with multiplication of the IDFT matrix or the DFT matrix. When multiplication of the IDFT matrix and the DFT matrix is used, MIMO detection can be performed without estimation of the channel matrix, so that operation complexity can be significantly reduced.

According to an embodiment of the disclosure, MIMO detection for the grouped blocks may be performed by another detection scheme. For example, schemes, such as Maximum Ratio Combining (MRC), Zero Forcing (ZF), Minimum Mean Square Error (MMSE), and QR decomposition may be used.

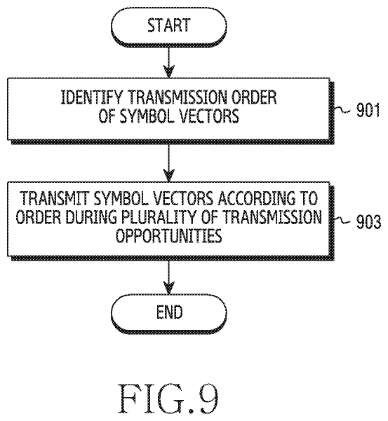

FIG. 9 is a flowchart illustrating a process of configuring an effective channel in a BCCB form in a wireless communication system according to an embodiment of the disclosure. FIG. 9 illustrates a method of operating a device (for example, the transmission device 110).

Referring to FIG. 9, in operation 901, the device identifies the transmission order of symbol vectors. The device generates symbol vectors corresponding to the number of subarrays used by the device and identifies symbol vectors to be transmitted in the same transmission opportunity. For example, the device identifies scheduling of transmission of the symbol vectors. In some embodiments, when scheduling of a transmission of symbol vectors is performed by the first device, the first device identifies a transmission order of the symbol vectors. The first device identifies scheduling of a transmission of the symbol vectors. The first device transmits information indicating a scheduling result to the second device. In some embodiments, when the scheduling of the transmission of the symbol vectors is performed by the second device, the first device receives information indicating the scheduling result from the second device.

In operation 903, the device transmits symbol vectors according to the order during a plurality of transmission opportunities. The device may transmit each of the symbol vectors multiple times during the plurality of transmission opportunities. Symbol vectors transmitted during the plurality of transmission opportunities may be different from each other. For example, the device may transmit symbol vectors according to the order illustrated in FIG. 8A.

In the embodiment described with reference to FIG. 9, the device identifies scheduling of transmission of the symbol vectors. The scheduling may be performed by the device or a counterpart device (for example, the reception device 120). When the scheduling is performed by the device, the device may transmit information indicating the scheduling result to the counterpart device. On the other hand, when the scheduling is performed by the counterpart device, the device may receive information indicating the scheduling result from the counterpart device.

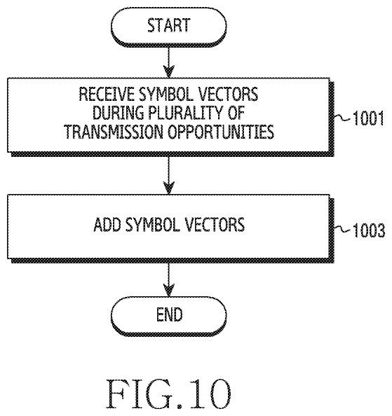

FIG. 10 is a flowchart illustrating a process for detecting symbols based on an effective channel in a BCCB form in a wireless communication system according to an embodiment of the disclosure. FIG. 10 illustrates a method of operating a device (for example, the reception device 120).

Referring to FIG. 10, in operation 1001, the device receives symbol vectors during a plurality of transmission opportunities. Different combinations of symbol vectors are received during the plurality of transmission opportunities. Each symbol vector may be received multiple times during the plurality of transmission opportunities.

In operation 1003, the device adds symbol vectors. The device sets an effective channel for the remaining symbol vectors expect for symbol vectors transmitted in each transmission opportunity as 0 and adds the symbol vectors experiencing the effective channel. For example, the device may generate one effective reception symbol vector by adding symbol vectors in the same way as that illustrated in FIG. 8A. Accordingly, the effective channel having the BCCB form may be configured.

In the embodiment described with reference to FIG. 10, the device adds the received symbol vectors. At this time, since the effective channel for the remaining symbol vectors except for the transmitted symbol vectors should be set as 0, the scheduling result of the symbol vectors is required. Accordingly, the device identifies scheduling of transmission of the symbol vectors before receiving the symbol vectors. The scheduling may be performed by the device or a counterpart device (for example, the transmission device 110). When the scheduling is performed by the device, the device may transmit information indicating the scheduling result to the counterpart device. On the other hand, when the scheduling is performed by the counterpart device, the device may receive information indicating the scheduling result from the counterpart device.

According to the above-described various embodiments of the disclosure, OAM multiplexing transmission is performed using UCAs. According to an embodiment of the disclosure, OAM multiplexing transmission may be performed using another type of array that is not the UCA. For example, OAM multiplexing transmission may be performed using antenna elements which are one-dimensionally or two-dimensionally linearly arranged, such as a Uniform Linear Array (ULA) or a Uniform Rectangular Array (URA).

When a condition under which an interval between antenna elements and an interval between antenna arrays are required is satisfied even though the ULA or the URA is used, the channel matrix may have the circulant or skew-circulant form.

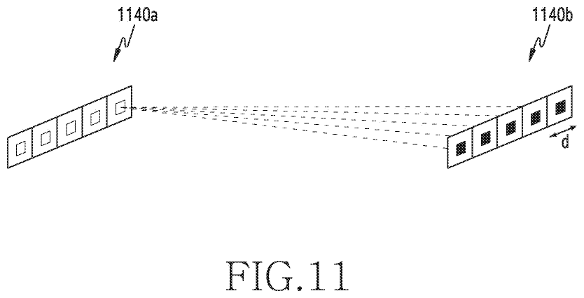

FIG. 11 illustrates an operation of communication using ULAs in a wireless communication system according to an embodiment of the disclosure.

Referring to FIG. 11, a transmission antenna array 1140a having the size of 1×5 and a reception antenna array 1140b having the size of 1×5 are used. A channel matrix between two parallel antenna arrays 1140a and 1140b may be expressed as Equation 9 below.

$$[ \begin{matrix}a & b & c & d & e \\ ke & a & b & c & d \\ kd & ke & a & b & c \\ kc & kd & ke & a & b \\ kb & kc & kd & ke & a\end{matrix} ] = [ \begin{matrix}1 & & & & \\ & ω & & & \\ & & {ω}^{2} & & \\ & & & {ω}^{3} & \\ & & & & {ω}^{4}\end{matrix} ] [ \begin{matrix}a & ω b & {ω}^{2} c & {ω}^{3} d & {ω}^{4} e \\ {ω}^{4} e & a & ω b & {ω}^{2} c & {ω}^{3} d \\ {ω}^{3} d & {ω}^{4} e & a & ω b & {ω}^{2} c \\ {ω}^{2} c & {ω}^{3} d & {ω}^{4} e & a & ω b \\ ω b & {ω}^{2} c & {ω}^{3} d & {ω}^{4} e & a\end{matrix} ] [ \begin{matrix}1 & & & & \\ & {ω}^{- 1} & & & \\ & & {ω}^{- 2} & & \\ & & & {ω}^{- 3} & \\ & & & & {ω}^{- 4}\end{matrix} ] \qquad Equation 9$$

In Equation 9, a, b, c, d, and e denote channel coefficients which can be expressed as complex numbers, k denotes a constant corresponding to an interval between antenna elements, and ω denotes a value derived from k. For example, k=ω5.

Referring to Equation 9, a channel matrix is a k-circulant matrix. A channel matrix on the left-hand side may be decomposed to multiplication of a matrix having 1, ω, ω2, ω3, and ω4 as diagonal elements, a circulant matrix, and a matrix having 1, ω, ω-2, ω-3, and ω-4 as diagonal elements. The circulant matrix is diagonalized by multiplication of an IDFT matrix and a DFT matrix, and thus the above-described MIMO detection schemes may be applied thereto.

A condition for allowing OAM multiplexing transmission using the ULA is described below. The channel matrix between two ULAs is also expressed as Equation 10 below.

$$H = \frac{λ}{4 π D} [ \begin{matrix}{e}^{- \frac{2 π {d}^{2}}{λ D} \frac{{0}^{2}}{2}} & {e}^{- \frac{2 π {d}^{2}}{λ D} \frac{{1}^{2}}{2}} & {e}^{- \frac{2 π {d}^{2}}{λ D} \frac{{2}^{2}}{2}} & {e}^{- \frac{2 π {d}^{2}}{λ D} \frac{{3}^{2}}{2}} & {e}^{- \frac{2 π {d}^{2}}{λ D} \frac{{4}^{2}}{2}} \\ {e}^{- \frac{2 π {d}^{2}}{λ D} \frac{{1}^{2}}{2}} & {e}^{- \frac{2 π {d}^{2}}{λ D} \frac{{0}^{2}}{2}} & {e}^{- \frac{2 π {d}^{2}}{λ D} \frac{{1}^{2}}{2}} & {e}^{- \frac{2 π {d}^{2}}{λ D} \frac{{2}^{2}}{2}} & {e}^{- \frac{2 π {d}^{2}}{λ D} \frac{{3}^{2}}{2}} \\ {e}^{- \frac{2 π {d}^{2}}{λ D} \frac{{2}^{2}}{2}} & {e}^{- \frac{2 π {d}^{2}}{λ D} \frac{{1}^{2}}{2}} & {e}^{- \frac{2 π {d}^{2}}{λ D} \frac{{0}^{2}}{2}} & {e}^{- \frac{2 π {d}^{2}}{λ D} \frac{{1}^{2}}{2}} & {e}^{- \frac{2 π {d}^{2}}{λ D} \frac{{2}^{2}}{2}} \\ {e}^{- \frac{2 π {d}^{2}}{λ D} \frac{{3}^{2}}{2}} & {e}^{- \frac{2 π {d}^{2}}{λ D} \frac{{2}^{2}}{2}} & {e}^{- \frac{2 π {d}^{2}}{λ D} \frac{{1}^{2}}{2}} & {e}^{- \frac{2 π {d}^{2}}{λ D} \frac{{0}^{2}}{2}} & {e}^{- \frac{2 π {d}^{2}}{λ D} \frac{{1}^{2}}{2}} \\ {e}^{- \frac{2 π {d}^{2}}{λ D} \frac{{4}^{2}}{2}} & {e}^{- \frac{2 π {d}^{2}}{λ D} \frac{{3}^{2}}{2}} & {e}^{- \frac{2 π {d}^{2}}{λ D} \frac{{2}^{2}}{2}} & {e}^{- \frac{2 π {d}^{2}}{λ D} \frac{{1}^{2}}{2}} & {e}^{- \frac{2 π {d}^{2}}{λ D} \frac{{0}^{2}}{2}}\end{matrix} ] \qquad Equation 10$$

In Equation 10, H denotes a channel matrix, λ denotes a wavelength of a signal, D denotes a distance between the center of a transmission antenna array and the center of a reception antenna array, and d denotes a distance between antenna elements.

Since the channel matrix in Equation 10 should be a k-circulant matrix, Equation 11 below should be satisfied.

$$\frac{2 π {d}^{2}}{λ D} \cdot \frac{{4}^{2} - {1}^{2}}{2} ≡ \frac{2 π {d}^{2}}{λ D} \cdot \frac{{3}^{2} - {2}^{2}}{2} ( mod 2 π ) \qquad Equation 11$$

In Equation 11, λ denotes a wavelength of a signal, D denotes a distance between the center of a transmission antenna array and the center of a reception antenna array, and d denotes a distance between antenna elements.

In order to satisfy Equation 11, the distance between antenna elements, the wavelength of the signal, and the distance between antenna arrays should satisfy the relation of Equation 12 below.

$$d = \sqrt{\frac{λ D}{5}} \qquad Equation 12$$

In Equation 12, d denotes a distance between antenna elements, λ denotes a wavelength of a signal, and D denotes a distance between the center of a transmission antenna array and the center of a reception antenna array.

Similar to the embodiments using the ULAs, OAM multiplexing transmission using the URA may be performed.

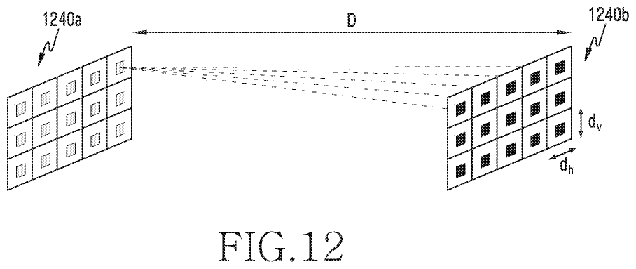

FIG. 12 illustrates an operation of communication using URAs in a wireless communication system according to an embodiment of the disclosure.

Referring to FIG. 12, a transmission antenna array 1240a having the size of 3×5 and a reception antenna array 1240b having the size of 3×5 are used. A channel matrix between two parallel antenna arrays 1240a and 1240b may be expressed as Equation 13 below.

$$Equation 13$$

$$H = \frac{λ}{4 π D} [ \begin{matrix}{e}^{- \frac{2 π {d}_{h}^{2}}{λ D} \frac{{0}^{2}}{2}} & {e}^{- \frac{2 π {d}_{h}^{2}}{λ D} \frac{{1}^{2}}{2}} & {e}^{- \frac{2 π {d}_{h}^{2}}{λ D} \frac{{2}^{2}}{2}} & {e}^{- \frac{2 π {d}_{h}^{2}}{λ D} \frac{{3}^{2}}{2}} & {e}^{- \frac{2 π {d}_{h}^{2}}{λ D} \frac{{4}^{2}}{2}} \\ {e}^{- \frac{2 π {d}_{h}^{2}}{λ D} \frac{{1}^{2}}{2}} & {e}^{- \frac{2 π {d}_{h}^{2}}{λ D} \frac{{0}^{2}}{2}} & {e}^{- \frac{2 π {d}_{h}^{2}}{λ D} \frac{{1}^{2}}{2}} & {e}^{- \frac{2 π {d}_{h}^{2}}{λ D} \frac{{2}^{2}}{2}} & {e}^{- \frac{2 π {d}_{h}^{2}}{λ D} \frac{{3}^{2}}{2}} \\ {e}^{- \frac{2 π {d}_{h}^{2}}{λ D} \frac{{2}^{2}}{2}} & {e}^{- \frac{2 π {d}_{h}^{2}}{λ D} \frac{{1}^{2}}{2}} & {e}^{- \frac{2 π {d}_{h}^{2}}{λ D} \frac{{0}^{2}}{2}} & {e}^{- \frac{2 π {d}_{h}^{2}}{λ D} \frac{{1}^{2}}{2}} & {e}^{- \frac{2 π {d}_{h}^{2}}{λ D} \frac{{2}^{2}}{2}} \\ {e}^{- \frac{2 π {d}_{h}^{2}}{λ D} \frac{{3}^{2}}{2}} & {e}^{- \frac{2 π {d}_{h}^{2}}{λ D} \frac{{2}^{2}}{2}} & {e}^{- \frac{2 π {d}_{h}^{2}}{λ D} \frac{{1}^{2}}{2}} & {e}^{- \frac{2 π {d}_{h}^{2}}{λ D} \frac{{0}^{2}}{2}} & {e}^{- \frac{2 π {d}_{h}^{2}}{λ D} \frac{{1}^{2}}{2}} \\ {e}^{- \frac{2 π {d}_{h}^{2}}{λ D} \frac{{4}^{2}}{2}} & {e}^{- \frac{2 π {d}_{h}^{2}}{λ D} \frac{{3}^{2}}{2}} & {e}^{- \frac{2 π {d}_{h}^{2}}{λ D} \frac{{2}^{2}}{2}} & {e}^{- \frac{2 π {d}_{h}^{2}}{λ D} \frac{{1}^{2}}{2}} & {e}^{- \frac{2 π {d}_{h}^{2}}{λ D} \frac{{0}^{2}}{2}}\end{matrix} ] ⊗ [ \begin{matrix}{e}^{- \frac{2 π {d}_{v}^{2}}{λ D} \frac{{0}^{2}}{2}} & {e}^{- \frac{2 π {d}_{v}^{2}}{λ D} \frac{{1}^{2}}{2}} & {e}^{- \frac{2 π {d}_{v}^{2}}{λ D} \frac{{2}^{2}}{2}} \\ {e}^{- \frac{2 π {d}_{v}^{2}}{λ D} \frac{{1}^{2}}{2}} & {e}^{- \frac{2 π {d}_{v}^{2}}{λ D} \frac{{0}^{2}}{2}} & {e}^{- \frac{2 π {d}_{v}^{2}}{λ D} \frac{{1}^{2}}{2}} \\ {e}^{- \frac{2 π {d}_{v}^{2}}{λ D} \frac{{2}^{2}}{2}} & {e}^{- \frac{2 π {d}_{v}^{2}}{λ D} \frac{{1}^{2}}{2}} & {e}^{- \frac{2 π {d}_{v}^{2}}{λ D} \frac{{0}^{2}}{2}}\end{matrix} ]$$

In Equation 13, H denotes a channel matrix, λ denotes a wavelength of a signal, D denotes a distance between the center of a transmission antenna array and the center of a reception antenna array, dₕ denotes a distance between antenna elements on a horizontal axis, and dᵥ denotes a distance between antenna elements on a vertical axis.

In Equation 13, a left matrix among two matrixes conducting Kronecker product is the same as a channel matrix in the case in which the ULA is used. Accordingly, when the channel matrix is decomposed according to the above-described method, a matrix having a circulant block structure may be obtained.

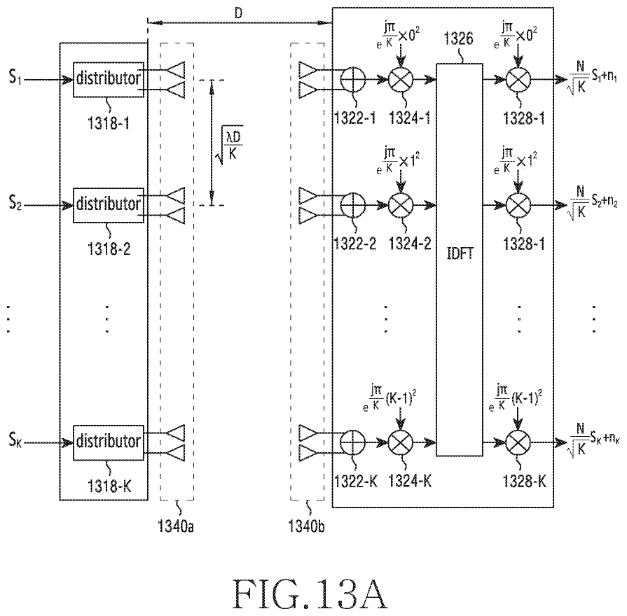

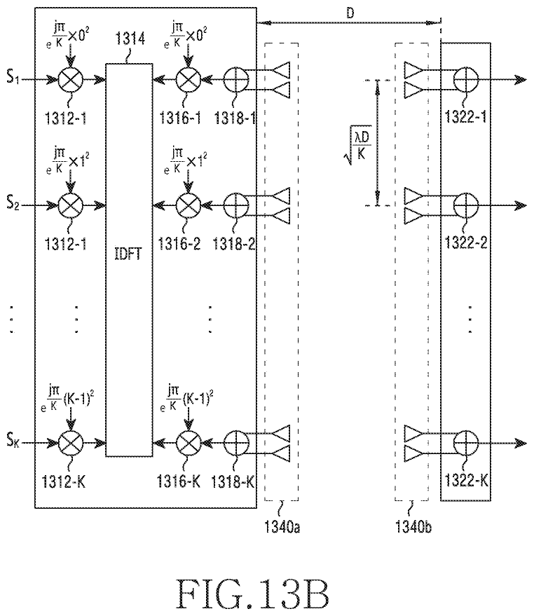

As described with reference to FIGS. 11 and 12, OAM multiplexing transmission using the ULA or URA may be performed. In the aforementioned examples, each of the antenna elements included in the antenna array transmits a separate symbol. In other words, each antenna element corresponds to one stream. However, according to an embodiment of the disclosure, a plurality of antenna elements may be used to transmit one stream. For example, antenna elements may be divided into a plurality of subsets, each subset may correspond to one stream, and antenna elements included in one subset may be used to perform beamforming. Accordingly, in addition to a multiplexing gain, a beamforming gain may be further obtained. In this case, arrangement of antennas and a signal processing procedure are as illustrated in FIG. 13A or FIG. 13B below.

FIG. 13A illustrates an operation of communication using ULAs in a wireless communication system according to an embodiment of the disclosure, and FIG. 13B illustrates an operation of communication using ULAs in a wireless communication system according to an embodiment of the disclosure.

Referring to FIGS. 13A and 13B, antenna elements included in each of a transmission antenna array 1340a and a reception antenna array 1340b are divided into K antenna subsets, and each antenna subset includes two antenna elements. Here, the antenna subset including two antenna elements is only an example, and one subset may include three or more antenna elements according to another embodiment. An interval between the transmission antenna array 1340a and the reception antenna array 1340b is D, and an interval between antenna subsets is

$$\sqrt{\frac{λ D}{K}} .$$

An interval between antenna elements included in one antenna subset may be

$$\frac{λ}{2} or \frac{λ}{4} .$$

FIG. 13A illustrates a structure in a case in which processing for separating signals for each stream is performed by the reception device of the disclosure.

Referring to FIG. 13A, symbols s₁ to s_{K} are transmitted. Each of the symbols s₁ to s_{K} are transmitted through one antenna subset. The symbols s₁ to s_{K} are distributed to antenna elements within antenna subsets corresponding to distributors 1318-1 to 1318-K. According to an embodiment of the disclosure, within one antenna subset, weights may be assigned to antenna elements. The weights may be the same as each other or different from each other. The reception device receives signals through the reception antenna array 1340b including antenna subsets and adds the signals for each antenna subset through adders 1322-1 to 1322-K. The reception device multiplies the added signals by

$${e}^{\frac{j π}{K} \times {0}^{2}} , {e}^{\frac{j π}{K} \times {1}^{2}} , … , {e}^{\frac{j π}{K} \times {( K - 1 )}^{2}}$$

through multipliers 1324-1 to 1324-K and performs an IDFT operation using an IDFT block 1326. Thereafter, the reception device multiplies the signals added to an IDFT-operated signal stream by

$${e}^{\frac{j π}{K} \times {0}^{2}} , {e}^{\frac{j π}{K} \times {1}^{2}} , … , {e}^{\frac{j π}{K} \times {( K - 1 )}^{2}}$$

through multipliers 1328-1 to 1328-K. Accordingly, signals for each stream may be derived in the form added to noise.

FIG. 13B illustrates an operation of communication using ULAs in a wireless communication system according to an embodiment of the disclosure. The transmission device transmits signals through the transmission antenna array 1340a including antenna subsets. Compared to FIG. 13A, at least some of the operations performed by the reception device in FIG. 13A may be performed by the transmission device in FIG. 13B.

Referring to FIG. 13B, the transmission device multiplies symbols s1 to sK by

$${e}^{\frac{j π}{K} \times {0}^{2}} , {e}^{\frac{j π}{K} \times {1}^{2}} , … , {e}^{\frac{j π}{K} \times {( K - 1 )}^{2}}$$

through multipliers 1312-1 to 1312-K and performs an IDFT operation using an IDFT block 1314. Thereafter, the transmission device multiplies signals added to an IDFT-operated signal stream by

$${e}^{\frac{j π}{K} \times {0}^{2}} , {e}^{\frac{j π}{K} \times {1}^{2}} , … , {e}^{\frac{j π}{K} \times {( K - 1 )}^{2}}$$

through multipliers 1316-1 to 1316-K, distributes the signals to antenna elements within each antenna subset through distributors 1318-1 to 1318-K, and transmits the signals through the transmission antenna array 1340. In response thereto, the reception device receives signals through the reception antenna array 1340b, adds the signals for each antenna subset, and derives the signals for each stream in the form added to noise.

The structure for additionally acquiring the beamforming gain in the embodiments described with reference to FIGS. 13A and 13B may be selectively used when a channel quality (for example, an SNR) is equal to or lower than a threshold value. For example, when the channel quality is higher than or equal to a threshold value, only multiplexing is performed. When the channel quality is lower than the threshold value, multiplexing and beamforming may be performed together. The threshold value may vary depending on the number of antenna elements or the number of streams. For example, the threshold value may increase as the number of antenna elements increases. In one example, the threshold of the channel quality according to the number of antenna elements may be defined as the following the table 1.

TABLE 1

| | # of antenna elements | | | | | |
|---|---|---|---|---|---|---|
| | 128 | 256 | 512 | 1024 | . . . | ∞ |
| Threshold[dB] | 5.9005 | 5.9175 | 5.9261 | 5.9309 | . . . | 5.9346 |

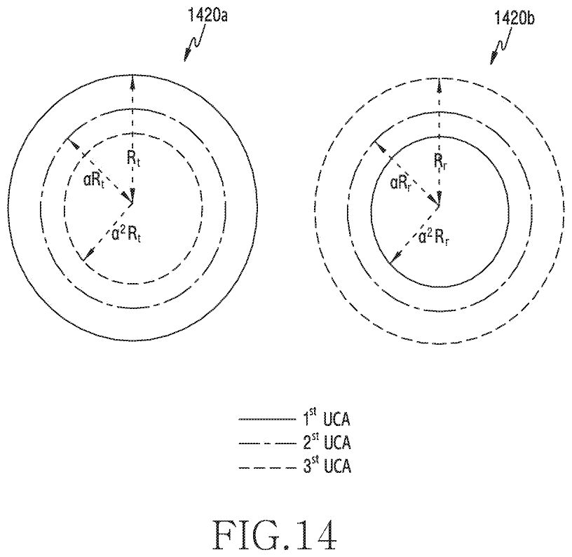

In various embodiments of the disclosure, OAM multiplexing transmission using the one-dimensional or two-dimensional linear array has been described. According to an embodiment of the disclosure, the performance may be further improved by using UCAs but properly controlling the interval between UCAs having the same center. An example of controlling the interval between UCAs according to an optimization condition will be described below with reference to FIG. 14.

FIG. 14 illustrates an operation of UCAs in a wireless communication system according to an embodiment of the disclosure.

Referring to FIG. 14, a transmission antenna array 1420a and a reception antenna array 1420b are a set of UCAs. Referring to FIG. 14, the transmission antenna array 1420a includes three UCAs, and the reception antenna array 1420b includes three UCAs. Three UCAs included in the transmission antenna array 1420a or the reception antenna array 1420b have the same center and different diameters. A ratio of the three UCAs may be designed to be 1:α:α2. In this case, a channel matrix may be expressed as Equation 14 below.

$$H \approx exp ( - j \frac{2 π}{λ} ( D + \frac{{R}_{r}^{2} + {R}_{t}^{2}}{2 D} ) ) ( exp ( j \frac{2 π {R}_{r} {R}_{t}}{λ D} cos ( θ - 2 π ( n - m ) / N ) ) ) \qquad Equation 14$$

In Equation 14, H denotes a channel matrix between a transmission UCA and a reception UCA, λ denotes a wavelength of a signal, D denotes a distance between the center of a transmission UCA and the center of a reception UCA, Rᵣ denotes a radius of a reception UCA, Rₜ denotes a radius of a reception UCA, n denotes an antenna element index of a transmission UCA, m denotes an antenna element index of a transmission UCA, and N denotes the number of antenna elements of a transmission UCA.

When UCAs having diameters of the ratio as illustrated in FIG. 14 are used, the channel matrix may be expressed as multiplication of a block Toeplitz matrix with circulant blocks and a diagonal matrix. For example, the channel matrix may be expressed as Equation 15 below.

$$H = [ \begin{matrix}{H}_{1 , 1} & {H}_{1 , 2} & {H}_{1 , 3} \\ {H}_{2 , 1} & {H}_{2 , 2} & {H}_{2 , 3} \\ {H}_{3 , 1} & {H}_{3 , 2} & {H}_{3 , 3}\end{matrix} ] \\ {H}_{1 , 1} = exp ( - j \frac{2 π}{λ} ( D + \frac{{α}^{4} {R}_{r}^{2} + {α}^{0} {R}_{t}^{2}}{2 D} ) ) exp ( j \frac{2 π {α}^{2} {R}_{r} {R}_{t}}{λ D} cos ( 2 π ( n - m ) / N ) ) \\ {H}_{1 , 2} = exp ( - j \frac{2 π}{λ} ( D + \frac{{α}^{4} {R}_{r}^{2} + {α}^{2} {R}_{t}^{2}}{2 D} ) ) exp ( j \frac{2 π {α}^{3} {R}_{r} {R}_{t}}{λ D} cos ( 2 π ( n - m ) / N ) ) \\ {H}_{1 , 3} = exp ( - j \frac{2 π}{λ} ( D + \frac{{α}^{4} {R}_{r}^{2} + {α}^{4} {R}_{t}^{2}}{2 D} ) ) exp ( j \frac{2 π {α}^{4} {R}_{r} {R}_{t}}{λ D} cos ( 2 π ( n - m ) / N ) ) \\ {H}_{2 , 1} = exp ( - j \frac{2 π}{λ} ( D + \frac{{α}^{2} {R}_{r}^{2} + {α}^{0} {R}_{t}^{2}}{2 D} ) ) exp ( j \frac{2 π {α}^{1} {R}_{r} {R}_{t}}{λ D} cos ( 2 π ( n - m ) / N ) ) \\ {H}_{2 , 2} = exp ( - j \frac{2 π}{λ} ( D + \frac{{α}^{2} {R}_{r}^{2} + {α}^{2} {R}_{t}^{2}}{2 D} ) ) exp ( j \frac{2 π {α}^{2} {R}_{r} {R}_{t}}{λ D} cos ( 2 π ( n - m ) / N ] ] \\ {H}_{2 , 3} = exp ( - j \frac{2 π}{λ} ( D + \frac{{α}^{2} {R}_{r}^{2} + {α}^{4} {R}_{t}^{2}}{2 D} ) ) exp ( j \frac{2 π {α}^{3} {R}_{r} {R}_{t}}{λ D} cos ( 2 π ( n - m ) / N ) ) \\ {H}_{3 , 1} = exp ( - j \frac{{2}_{π}}{λ} ( D + \frac{{α}^{0} {R}_{r}^{2} + {α}^{0} {R}_{t}^{2}}{2 D} ) ) exp ( j \frac{2 π {α}^{0} {R}_{r} {R}_{t}}{λ D} cos ( 2 π ( n - m ) / N ) ) \\ {H}_{3 , 2} = exp ( - j \frac{2 π}{λ} ( D + \frac{{α}^{0} {R}_{r}^{2} + {α}^{2} {R}_{t}^{2}}{2 D} ) ) exp ( j \frac{2 {πα}^{1} {R}_{r} {R}_{t}}{λ D} cos ( 2 π ( n - m ) / N ) ) \\ {H}_{3 , 3} = exp ( - j \frac{2 π}{λ} ( D + \frac{{α}^{0} {R}_{r}^{2} + {α}^{4} {R}_{t}^{2}}{2 D} ) ) exp ( j \frac{2 {πα}^{2} {R}_{r} {R}_{t}}{λ D} cos ( 2 π ( n - m ) / N ) ) \qquad Equation 15$$

In Equation 15, H denotes a channel matrix, H_{l,k} denotes a matrix having the form of a circulant block as a channel matrix between a k^{th} subarray of a transmission antenna array and an l^{th} subarray of a reception antenna array, λ denotes a wavelength of a signal, D denotes a distance between the center of a transmission UCA and the center of a reception UCA, a denotes a value related to a ratio between radiuses of UCAs, Rᵣ denotes a radius of a reception UCA, Rₜ denotes a radius of a reception UCA, n denotes an antenna element index of a transmission UCA, m denotes an antenna element index of a transmission UCA, and N denotes the number of antenna elements of a transmission UCA.

When UCAs illustrated in FIG. 14 are used, signal processing may be performed by one of the aforementioned schemes. Alternatively, the reception device may process the signal such that an effective channel for a reception signal becomes the Toeplitz matrix for each subarray and may detect a transmission signal. In order to detect a signal, reception schemes, such as SVD, MRC, ZF, MMSE, and QR may be used.

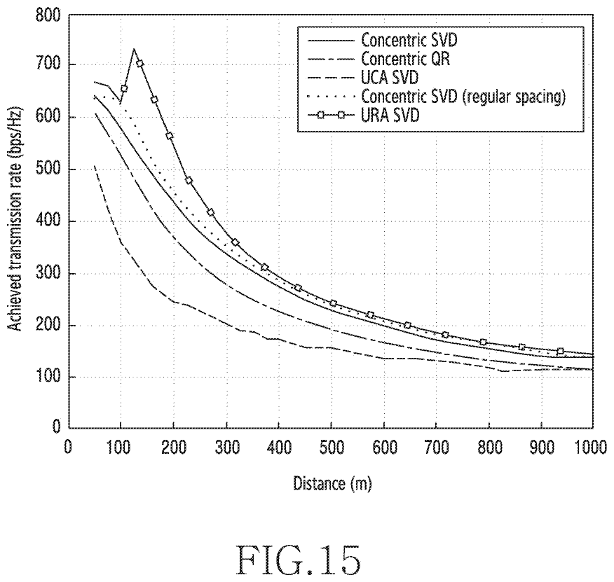

FIG. 15 illustrates a performance of a transmission scheme according to an embodiment of the disclosure.

Referring to FIG. 15, concentric SVD denotes a channel capacity when the antenna structure of FIG. 14 is used, concentric QR denotes a data rate achieved when the antenna structure of FIG. 14 is used and Successive Interference Cancellation (SIC) based on QR decomposition corresponding to a reception scheme is used, UCA SVD denotes a channel capacity when a UCA is used, concentric SVD (regular spacing) denotes a channel capacity when a concentric UCA is arranged at regular spacing, and URA SVD denotes a channel capacity when a URA is used.

Such a simulation is conducted with the same size of all antenna arrangements. For example, the largest diameter of the concentric UCA and the length of one side of the URA are configured to be the same as each other. First, URA SVD having the highest performance may achieve the capacity with low complexity through the transmission and reception scheme of FIG. 5C, and particularly, lower complexity may be obtained using MRC or MRT in

$$125 m ( d = \sqrt{\frac{λ D}{N}} ) .$$

The concentric SVD and QR has a little performance loss due to a lower rank than the concentric SVD (regular spacing) but may be implemented with lower complexity since each block becomes the Toeplitz form in FIG. 5C. Referring to the simulation result, an achieved data rate can be increased when an interval between antennas is widened using another structure compared to the case in which the UCA is used in a massive LOS MIMO system, and it is noted that low complexity can be implemented by the proposed algorithms.

The above-described various embodiments may be implemented by devices (for example, the transmission device 110 and the reception device 120) in a LOS environment. According to an embodiment of the disclosure, in a condition under which two devices may be arranged at a predetermined location without any obstacle, the signal transmission and reception scheme according to the above-described various embodiments may be applied.

One use case corresponds to the use by a device that wirelessly provides content. For example, the device that provides content may be a device (for example, kiosk) that provides content in an electronic file format. Specifically, a first device that provides content may be designed to have a space on which a second device (for example, a smartphone or a dedicated terminal) of the user can be placed. In this case, a LOS channel environment may be formed, and a distance between antennas of the first device and antennas of the second device may be fixed in advance. In this case, it is expected that a change in a channel over time is small. When the user places the second device on a predetermined location of the first device in a desired position, the first device and the second device may transmit data according to the above-described various embodiments.

Another use case corresponds to the use by two user devices. In this case, relative arrangement of devices is performed by the user. To this end, at least one device may display guide information (for example, an image or video guide) for relative arrangement of two user devices. Further, at least one device may evaluate relative arrangement between two devices through a scheme, such as channel estimation or location estimation and provide feedback indicating whether an environment in which the schemes can be used is formed (for example, notification output). In some embodiments, the method of the present disclosure comprises implementing the information for relative arrangement of the first device and the second device. The information includes guide information including one of an image or a video guide.

Another use case corresponds to the use by devices having no mobility. When there is no mobility, a distance between antenna arrays of two devices and antenna arrangement may be set as fixed parameters. Accordingly, the above-described various embodiments can be easily applied. For example, when a backhaul link between base stations of a cellular communication system or between a base station and another network device is a wireless link, the signal transmission and reception scheme according to the above-described various embodiments may be used.

Methods disclosed in the claims and/or methods according to various embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in nonvolatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks, such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method of operating a first device in a wireless communication system, the method comprising:
identifying a plurality of subarrays formed from a planar lattice array; and
transmitting symbols to a second device through the plurality of subarrays,
wherein the subarrays form a plurality of Uniform Circulant Arrays (UCAs) from the planar lattice antenna array, and
wherein antenna elements allocated to each of the subarrays are located at equal intervals to have an equal distance from the center of the planar lattice array.

2. The method of claim 1, further comprising:
acquiring information on a channel matrix;
generating a first matrix diagonalized in units of blocks by multiplying the channel matrix by a Discrete Fourier Transform (DFT) matrix and an inverse DFT (IDFT) matrix;
generating a second matrix in which coefficients corresponding an equal mode are adjacent by grouping coefficients of the first matrix for each mode; and
determining a precoding matrix, based on the second matrix.

3. The method of claim 1, wherein the symbols are transmitted after being multiplied by a Discrete Fourier Transform (DFT) matrix.

4. The method of claim 3, wherein, before multiplication with the DFT matrix, the symbols are multiplied by the precoding matrix in the state in which the symbols are arranged for each mode and re-arranged for multiplication with the DFT matrix.

5. The method of claim 4, wherein the precoding matrix includes at least one right singular vector obtained by Singular Value Decomposition (SVD) for each of at least one block included in a matrix obtained by multiplying the channel matrix by a Discrete Fourier Transform (DFT) matrix and an inverse DFT (IDFT) matrix and permutating coefficients.

6. The method of claim 1,
wherein the transmitting of the symbols comprises transmitting each of the symbols at least two times during a plurality of transmission opportunities, and
wherein a first symbol set transmitted in a first transmission opportunity is at least partially different from a second symbol set transmitted in a second transmission opportunity.

7. A first device in a wireless communication system, the first device comprising:
a transceiver; and
at least one processor connected to the transceiver,
wherein the at least one processor is configured to:
identify a plurality of subarrays formed from a planar lattice array, and
transmit symbols to a second device through the plurality of subarrays,
wherein the subarrays form a plurality of Uniform Circulant Arrays (UCAs) from the planar lattice antenna array, and
wherein antenna elements allocated to each of the subarrays are located at equal intervals to have an equal distance from the center of the planar lattice array.

8. The first device of claim 7, wherein the at least one processor is further configured to:
acquire information on a channel matrix, generates a first matrix diagonalized in units of blocks by multiplying the channel matrix by a Discrete Fourier Transform (DFT) matrix and an inverse DFT (IDFT) matrix,
generate a second matrix in which coefficients corresponding an equal mode are adjacent by grouping coefficients of the first matrix for each mode, and
determine a precoding matrix, based on the second matrix.

9. The first device of claim 7, wherein the symbols are transmitted after being multiplied by a Discrete Fourier Transform (DFT) matrix.

10. The first device of claim 9, wherein, before multiplication with the DFT matrix, the symbols are multiplied by the precoding matrix in the state in which the symbols are arranged for each mode and re-arranged for multiplication with the DFT matrix.

11. The first device of claim 10, wherein the precoding matrix includes at least one right singular vector obtained by Singular Value Decomposition (SVD) for each of at least one block included in a matrix obtained by multiplying the channel matrix by a Discrete Fourier Transform (DFT) matrix and an inverse DFT (IDFT) matrix and permutating coefficients.

12. The first device of claim 7,
wherein the at least one processor is further configured to transmit each of the symbols at least two times during a plurality of transmission opportunities, and
wherein a first symbol set transmitted in a first transmission opportunity is at least partially different from a second symbol set transmitted in a second transmission opportunity.

13. A second device in a wireless communication system, the second device comprising:
a transceiver; and
at least one processor connected to the transceiver,
wherein the at least one processor is configured to:
identify a plurality of subarrays formed from a planar lattice array, and
receive symbols from a first device through the plurality of subarrays,
wherein the subarrays form a plurality of Uniform Circulant Arrays (UCAs) from the planar lattice antenna array, and
wherein antenna elements allocated to each of the subarrays are located at equal intervals to have an equal distance from the center of the planar lattice array.

14. The second device of claim 13, wherein the at least one processor is further configured to:
acquire information on a channel matrix, generates a first matrix diagonalized in units of blocks by multiplying the channel matrix by a Discrete Fourier Transform (DFT) matrix and an inverse DFT (IDFT) matrix,
generate a second matrix in which coefficients corresponding an equal mode are adjacent by grouping coefficients of the first matrix for each mode, and
determine a precoding matrix, based on the second matrix.

15. The second device of claim 13, wherein the symbols are received and multiplied by an inverse Discrete Fourier Transform (IDFT) matrix.

16. The second device of claim 15, wherein, after multiplication with the DFT matrix, the symbols are multiplied by the precoding matrix in the state in which the symbols are arranged for each mode.

17. The second device of claim 16, wherein the precoding matrix includes Hermitian of at least one left singular vector obtained by Singular Value Decomposition (SVD) for each of at least one block included in a matrix obtained by multiplying the channel matrix by a DFT matrix and an inverse DFT (IDFT) matrix and permutating coefficients.

18. The second device of claim 13,
wherein the at least one processor is further configured to receive each of the symbols at least two times during a plurality of transmission opportunities, and
wherein a first symbol set transmitted in a first transmission opportunity is at least partially different from a second symbol set transmitted in a second transmission opportunity.

19. The second device of claim 18, wherein the at least one processor is further configured to form an effective channel in a form of Block Circulant with Circulant Blocks (BCCB) by adding symbol sets received during the plurality of opportunities.
